(19) United States
(12) Patent Application Publication
(10) Pub. No.: US 2020/0049808 A1
(43) Pub. Date: Feb. 13, 2020

(54) TARGET POSITION ESTIMATION FROM CROSS TRANSMISSION REFLECTIONS OF UNSYNCHRONIZED RADARS

(71) Applicant: GM GLOBAL TECHNOLOGY OPERATIONS LLC, Detroit, MI (US)

(72) Inventors: Oded Bialer, Petah Tivak (IL); Amnon Jonas, Jerusalem (IL)

(21) Appl. No.: 16/100,326

(22) Filed: Aug. 10, 2018

(51) Int. Cl. G01S 13/00; G01S 13/32; G01S 13/93

(52) U.S. Cl. CPC G01S 13/003; G01S 2013/9389; G01S 13/931; G01S 13/32

(57) ABSTRACT

A vehicle, radar system for a vehicle and method of estimating a cross-transmission range of an object. The radar system includes a first radar, a second radar and a processor. The first radar transmits a test signal. The second radar is separated from the first radar by a selected distance and receive a total signal that includes the test signal received directly from the first radar and a reflection of the test signal from the target. The processor performs a non-linear operation on the total signal to obtain a cross-correlation term of the directly received test signal and the reflection signal, and estimate a cross-transmission range of the object from the cross-correlation term.

### INTRODUCTION

The subject disclosure relates to determining radar parameters of an object using radar signals and, in particular, to determining a position of an object using unsynchronized radars.

In vehicular radar systems, there are often multiple radars located on the vehicle. Each radar generally includes a transmitter and a receiver. The transmitter transmits a signal that is reflected from an object and is received at the receiver in order to determine a parameter of the object, such as a position of the object. By synchronizing multiple radars, these parameters can be determined using a signal transmitted from a radar at one location of the vehicle with a reflection of the signal received at another radar at another location of the vehicle. However, synchronization of radars requires a significant amount of additional processing circuitry and power needs. Accordingly, it is desirable to provide a system and method for determining a position of the object that does not require synchronized radars.

### SUMMARY

In one exemplary embodiment, a method of estimating a cross-transmission range of an object is disclosed. The method includes transmitting a test signal from a transmitter, receiving, at a receiver separated from the transmitter, a total signal that includes the test signal received directly from the transmitter and a reflection of the test signal from the object, performing a non-linear operation on the total signal to obtain a cross-correlation term of the directly received test signal and the reflection signal, and estimating the cross-transmission range of the object from the cross-correlation term.

In addition to one or more of the features described herein, the transmitter and the receiver are unsynchronized. Performing the non-linear operation further includes at least one of squaring the total signal, obtaining a scalar product of the total signal, and obtaining an absolute value of the total signal. The method further includes applying a bandpass filter to a result of the non-linear operation. The method further includes integrating the cross-correlation term to estimate the round trip delay between transmitter, object, and receiver. The method further includes applying a Fourier transform to the cross-correlation term and estimating the cross-transmission range of the object from the peak in a resulting Fourier spectrum. The method further includes combining the estimated cross-transmission range of the object from the cross-correlation term with an estimate of a self-transmission range of the object from a self-transmission echo.

In another exemplary embodiment, a radar system for a vehicle is disclosed. The radar system includes a first radar, a second radar and a processor. The first radar is configured to transmit a test signal. The second radar is separated from the first radar by a selected distance and is configured to receive a total signal that includes the test signal received directly from the first radar and a reflection of the test signal from the target. The processor is configured to perform a non-linear operation on the total signal to obtain a cross-correlation term of the directly received test signal and the reflection signal, and estimate a cross-transmission range of the object from the cross-correlation term.

In addition to one or more of the features described herein, the first radar and the second radar are unsynchronized. The processor is further configured to perform the non-linear operation by performing at least one of squaring the total signal, obtaining a scalar product of the total signal, and obtaining an absolute value of the total signal. The processor is further configured to apply a filter to a result of the non-linear operation. The processor is further configured to integrate the cross-correlation term to estimate the cross-transmission range of the object. The processor is further configured to combine the estimated cross-transmission range of the object from the cross-correlation term with an estimate of a self-transmission range of the object from a self-transmission echo. The processor is further configured to navigate the vehicle with respect to the object based on the estimated cross-transmission range.

In yet another exemplary embodiment, a vehicle is disclosed. The vehicle includes a first radar, a second radar and a processor. The first radar is configured to transmit a test signal. The second radar is separated from the first radar by a selected distance and is configured to receive a total signal that includes the test signal received directly from the first radar and a reflection of the test signal from the target. The processor is configured to perform a non-linear operation on the total signal to obtain a cross-correlation term of the directly received test signal and the reflection signal, and estimate a cross-transmission range of the object from the cross-correlation term.

In addition to one or more of the features described herein, the first radar and the second radar are unsynchronized. The processor is further configured to perform the non-linear operation by performing at least one of squaring the total signal, obtaining a scalar product of the total signal, and obtaining an absolute value of the total signal. The processor is further configured to apply a filter to a result of the non-linear operation. The processor is further configured to integrate the cross-correlation term to estimate the cross-transmission range of the object. The processor is further configured to combine the estimated cross-transmission range of the object from the cross-correlation term with an estimate of the self-transmission range of the object from a self-transmission echo.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle with an associated trajectory planning system in accordance with various embodiments;

FIG. 2 depicts the vehicle of FIG. 1 performing a method of determining a range of an object using a self-transmission echo from a single radar;

FIG. 3 illustrates a method of determining the range of the object using a cross-transmission echo;

FIG. 4 shows details of the illustrative radar system of the vehicle of FIG. 1;

FIG. 5 shows a flow chart illustrating a method for determining a range to an object using unsynchronized radars; and

FIG. 6 depicts a diagram illustrating the results of combining the results of self-transmission ranging and cross-transmission ranging.

### DETAILED DESCRIPTION

The following description is merely exemplary in nature and is not intended to limit the present disclosure, its application or uses. It should be understood that throughout the drawings, corresponding reference numerals indicate like or corresponding parts and features.

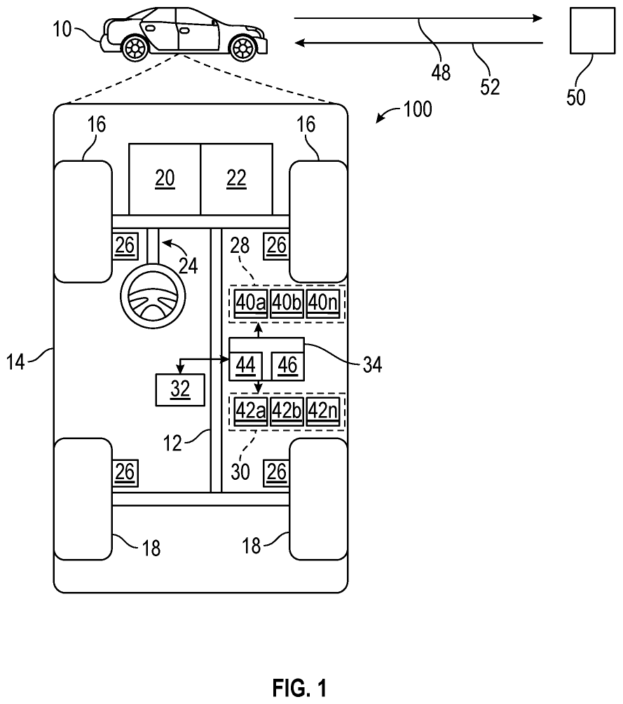

In accordance with an exemplary embodiment, FIG. 1 shows a vehicle 10 with an associated trajectory planning system depicted at 100 in accordance with various embodiments. In general, the trajectory planning system 100 determines a trajectory plan for automated driving of the vehicle 10. The vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16 and 18 are each rotationally coupled to the chassis 12 near a respective corner of the body 14.

In various embodiments, the vehicle 10 is an autonomous vehicle and the trajectory planning system 100 is incorporated into the autonomous vehicle 10 (hereinafter referred to as the autonomous vehicle 10). The autonomous vehicle 10 is, for example, a vehicle that is automatically controlled to carry passengers from one location to another. The autonomous vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, at least one data storage device 32, and at least one controller 34. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16 and 18. The brake system 26 may, in various embodiments, include friction brakes, brake by wire, a regenerative braking system such as an electric machine, and/or other appropriate braking systems. The steering system 24 influences a position of the of the vehicle wheels 16 and 18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors. In various embodiments, the vehicle 10 includes a radar system including an array of radar sensors, the radar sensors being located at various locations along the vehicle 10. In operation, a radar sensor sends out an electromagnetic pulse 48 that is reflected back at the vehicle 10 by one or more objects 50 in the field of view of the sensor. The reflected pulse 52 appears as one or more detections at the radar sensor.

The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as ventilation, music, lighting, etc. (not numbered).

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which includes an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

The trajectory planning system 100 navigates the autonomous vehicle 10 based on a determination of objects and/their locations within the environment of the vehicle. In various embodiments the controller 34 operates a plurality of radars at various locations on the vehicle 10 to determine a location (i.e., range, elevation and azimuth) of the object 50 using unsynchronized radars, in particular, using cross-transmission echoes between unsynchronized radars. The determined location can be used either alone or in combination with similar parameters obtained by single radar systems in order to provide range, azimuth and/or elevation of the object 50 for navigation purposes. Upon determining various parameters of the object, such as range, azimuth, elevation, velocity, etc., the controller 34 can operate the one or more actuator devices 42a-n, the propulsion system 20, transmission system 22, steering system 24 and/or brake 26 in order to navigate the vehicle 10 with respect to the object 50.

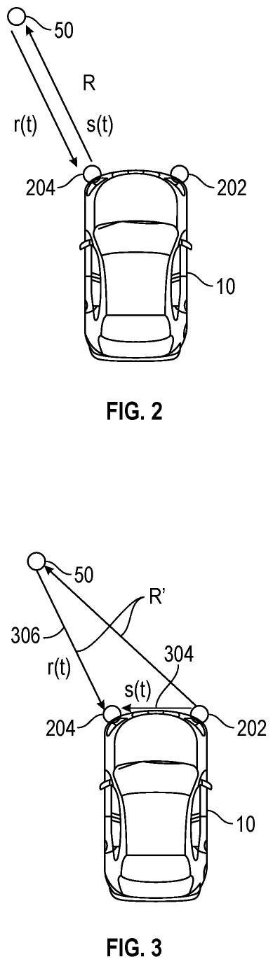

FIG. 2 depicts the vehicle 10 of FIG. 1 performing a method of determining a self-transmission range R of object 50 using a self-transmission echo from a single radar of vehicle 10. The vehicle 10 shows a first radar 202 and a second radar 204. Each of the first radar 202 and the second radar can include a transmitter and at least one receiver. Alternatively, each radar can include a transducer that operates as both transmitter and receiver.

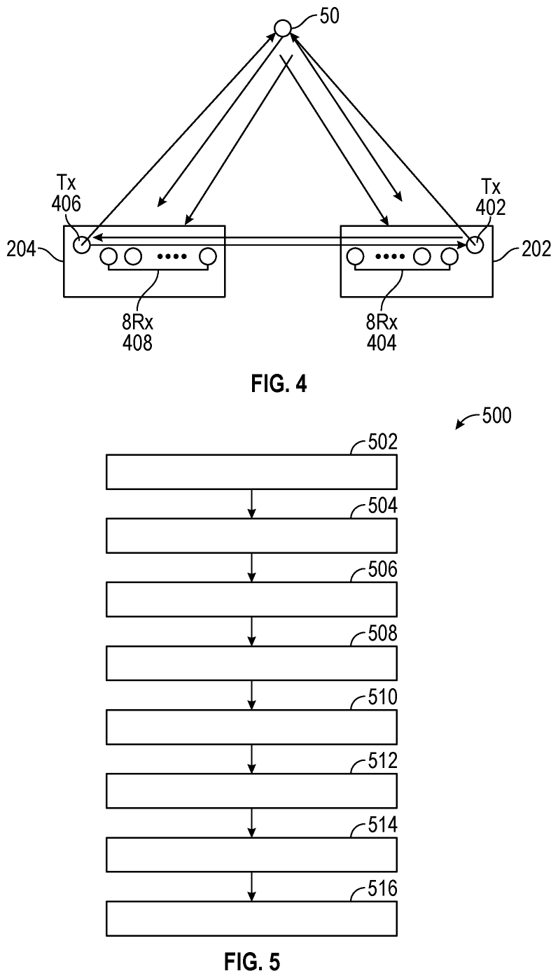

Referring to FIG. 4, FIG. 4 shows details of the illustrative radar system of vehicle 10. The first radar 202 includes a transmitter 402 for transmitting one or more test signals and a plurality of receivers 404 for receiving reflections of the one or more test signals. Similarly, the second radar 204 includes a transmitter 406 for transmitting one or more test signals and plurality of receivers 408 for receiving reflections of the one or more test signals. It is apparent that, while the first radar 202 and the second radar 404 are unsynchonized, a test signal transmitted from transmitter 402 of the first radar 202 can be received by the plurality of receivers 408 of the second radar 204, and a test signal transmitted from transmitter 406 of the second radar 204 can be received by the plurality of receivers 404 of the first radar 202. In various embodiments, the test signal is a linear modulated frequency (LFM) signal, also known as a chirp signal.

Returning to FIG. 2, the second radar 204 is shown illustrating the operation of a self-transmission echo for determining a self-transmission range of the object 104 with respect to vehicle 10. While the second radar 204 is shown for illustrative purposes, it is to be understood that the first radar 202 can also determine a range of object 50 using a self-transmission echo, either independently of the second radar 204 or in combination with the second radar 204. In a self-transmission echo, the second radar 204 transmits a test signal s(t) and receives a reflection r(t) of the test signal from the object 50. Since the transmitter and receiver of the second radar 204 (i.e., the same radar) are synchronized with each other, the self-transmission range R is obtained from a correlation of the reflected signal r(t) with the local radar transmitted signal s(t), as shown in Eq. (1):

$$R ∝ arg {max}_{μ} \int r ( t ) * s ( t - μ ) dt \qquad Eq . ( 1 )$$

where μ is a delay offset between the transmitted signal s(t) and received signal r(t). Eq. (1) is suitable for range determination when the transmitter and receiver are synchronized. However, Eq. (1) does not hold when using a transmitter and a receiver that are not synchronized.

FIG. 3 illustrates a method of determining the cross-transmission range R′ of the object 50 using a cross-transmission echo. The cross-transmission echo uses both the first radar 202 and the second radar 204. The first radar 202 and the second radar 204 are separated by a selected or known distance and are not synchronized with each other. Additionally, the first radar 202 and the second radar 204 are within a line-of-sight of each other. The cross-transmission range is a distance travelled from first radar 202 to the object 50 and then to second radar 204. In a more general sense, a cross-transmission range of an object is a range determined using a signal travelling between any two distinct radars by way of the object.

As an illustration of cross-transmission echo ranging, the first radar 202 generates a test signal s(t) (304) that propagates from the first radar 202 in all directions. The second radar 204 receives two signals as a result of the transmission of the test signal. First, the second radar 204 receives directly the test signal s(t) which has travelled directly from the first radar 202 to the second radar 204. Second, the second radar 204 receives a reflection r(t) (306) of the test signal 304 from object 50. The resultant total signal y(t) received at second radar 204 is given by Eq. (2):

y(t)=r(t)+s(t−r) Eq. (2)

where r(t) is the reflected signal 306 and s(t−r) is the directly received test signal 304. The variable τ is related to the distance between the first radar 202 and the second radar 204, which is a known quantity.

In order to obtain a cross-correlation term from the total signal y(t) of Eq. (2), a non-linear operation is performed on the total signal y(t). In various embodiments, the non-linear operation can include: squaring the total signal, performing a scalar product of the total signal, obtaining an absolute value of the total signal, etc. For illustrative purposes, Eq. (3) shows the results of squaring the total signal:

y²(t)=r²(t)+s²(t−τ)+2r(t)s(t−τ) Eq. (3)

The non-linear operation introduces terms that are the square of the reflection and the square of the test signal as well as a cross-correlation term, 2r(t)s(t−τ). Thus, performing the non-linear operation generates the cross-correlation term than can be used to determine a cross-transmission range from unsynchronized radars, using Eq. (1) or a similar equation. For a LFM test signal, the cross correlation term gives a sinusoidal signal such as sin(2πft+φ) or a complex exponential signal. exp(j2πft+φ). In either case, the frequency f is proportional to the round trip delay between the transmit antenna, the object and the receive antenna. Thus, the round trip delay is determined by estimating the frequency f of the cross-correlation term by applying a Fourier transform on the cross-correlation term. The peak value of the Fourier spectrum is the related to the round trip delay for a single object. For multiple objects at different positions, the Fourier transform produces multiple peaks, one for each of the multiple round trip delays related to the multiple objects. The Fourier transform is implemented by either a Discrete Fourier transform or a Fast Fourier transform, in various embodiments. One can apply a bandpass filter to the output of the Fourier transform. Cross-transmission range determination using cross-transmission echoes is discussed with respect to FIG. 5.

FIG. 5 shows a flow chart 500 illustrating a method for determining a range R to an object 204 using unsynchronized radars. In box 502, a test signal s(t) is generated at a first radar. In various embodiments, the test signal s(t) is a linear frequency modulated signal or “chirp” signal. In box 504, a total signal y(t) is received at a second radar unsynchronized with the first radar, the total signal being the summation of the test signal directly received from the first radar and a reflection of the test signal from the object.

In box 506, a non-linear operation is performed on the total signal. The non-linear operation produces the square of the reflection signal, the square of the directly-received signal and the cross-correlation term that includes a product of the reflection signal and the directly-received signal shifted in time by a time delay. The square of the reflection signal and the square of the directly-received signal are high frequency terms and DC (low frequency) terms. Therefore in box 508, a filter is applied to the signal in order to remove these terms. In various embodiments, the filter is a band-pass filter.

In box 510, the filtered signal (i.e., the cross-product term) is transformed into a frequency space using, for example, a Fourier transform. In box 512, the peaks of the cross-product term are located in frequency space. The peaks in the Fourier domain are proportional to and/or related to the cross-transmission ranges of the object. In box 514, an offset (cτ) is deduced, the offset being introduced by the direct path delay from the transmitter to the receiver. The peak in the Fourier spectrum is a measurement of the difference between the round trip delay (along the path from the transmitter to the object and to the receiver) and the delay τ along the direct path (between the transmitter and the receiver). The round trip delay measurement is adjusted by τ or by the corresponding distance measurement CT in order to eliminate the offset from the cross-transmission range calculations.

In box 516, the cross-transmission range measurements and the self-transmission range measurements are combined into a uniform beamforming signal. For a radar system including the first radar 202 and the second radar 204, both first radar 202 and second radar 204 can be used to determine a self-transmission range using a self-transmission echo. Furthermore, cross-transmission ranges can be determined using two cross-transmission echo ranges. Since, each radar has multiple transmitters and receivers, matrices A₁(θ), A₂(θ), A₃(θ), A₄(θ) correspond to the multiple transmitter and receiver paths for self-transmission echoes and cross transmission echoes. The combined ranging signal z(θ) is shown in Eq. (4):

z(θ)=A₁(θ)y₁+A₂(θ)y₂+A₃(θ)y₃+A₄(θ)y₄ Eq. (4)

where y₁ is a self-transmission range determined from a first radar, y₂ is a self-transmission range determined from a second radar, y₃ is a cross-transmission range determined by transmitting a test signal from a first radar and receiving the reflection at the second radar and y₄ is a cross-transmission range determined by transmitting a test signal from a second radar and receiving the reflection at the first radar. The combined ranging signal z(θ) can be provided to the processor 44 of FIG. 1 to indicate a position of the object 50 which is used to control navigating of the vehicle 10 with respect to the object 50.

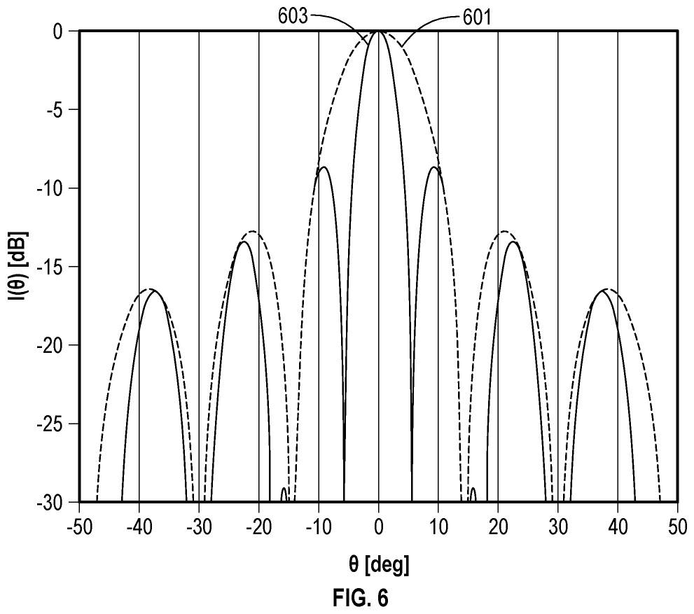

FIG. 6 depicts a diagram illustrating the results of combining the results of self-transmission ranging and cross-transmission ranging. Curve 601 shows peaks for an angular location of the object 50 using only a self-transmission ranging from a single radar. Curve 603 shows peaks for angular location of the object 50 using a combination of self-transmission and cross-transmission ranging methods disclosed herein. The beam width of each curve indicates an estimated location and resolution of the object obtained via the respective ranging method. The beam width of the curve 603 (from about −5° to +5°), which uses cross-transmission ranging, is decreased by at least a factor of 2 over the beam width of the curve 605 (from about −15° to +15°), which uses only the self-transmission ranging. Thus the angular resolution of the object 50 is increased by at least a factor of 2.

It is to be understood that use of additional cross-transmission echoes, as is possible using the multiple receivers of the radar system of FIG. 4 can increase a number of range estimations during cross-transmission ranging and can therefore be used to further reduce beam width or, equivalently, to increase the angular resolution of the object.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A method of estimating a cross-transmission range of an object, comprising:
transmitting a test signal from a transmitter;
receiving, at a receiver separated from the transmitter, a total signal that includes the test signal received directly from the transmitter and a reflection of the test signal from the object;
performing a non-linear operation on the total signal to obtain a cross-correlation term of the directly received test signal and the reflection signal; and
estimating the cross-transmission range of the object from the cross-correlation term.

2. The method of claim 1, wherein the transmitter and the receiver are unsynchronized.

3. The method of claim 1, wherein performing the non-linear operation further comprises at least one of: (i) squaring the total signal; (ii) obtaining a scalar product of the total signal; and (iii) obtaining an absolute value of the total signal.

4. The method of claim 1, further comprising applying a bandpass filter to a result of the non-linear operation.

5. The method of claim 1, further comprising integrating the cross-correlation term to estimate the round trip delay between transmitter, object, and receiver.

6. The method of claim 1, further comprising applying a Fourier transform to the cross-correlation term and estimating the cross-transmission range of the object from the peak in a resulting Fourier spectrum.

7. The method of claim 1, further comprising combining the estimated cross-transmission range of the object from the cross-correlation term with an estimate of a self-transmission range of the object from a self-transmission echo.

8. A radar system for a vehicle, comprising:
a first radar configured to transmit a test signal;
a second radar separated from the first radar by a selected distance, the second radar configured to receive a total signal that includes the test signal received directly from the first radar and a reflection of the test signal from the target; and
a processor configured to:
perform a non-linear operation on the total signal to obtain a cross-correlation term of the directly received test signal and the reflection signal; and
estimate a cross-transmission range of the object from the cross-correlation term.

9. The radar system of claim 8, wherein the first radar and the second radar are unsynchronized.

10. The radar system of claim 8, wherein the processor is further configured to perform the non-linear operation by performing at least one of: (i) squaring the total signal; (ii) obtaining a scalar product of the total signal; and (iii) obtaining an absolute value of the total signal.

11. The radar system of claim 8, wherein the processor is further configured to apply a filter to a result of the non-linear operation.

12. The radar system of claim 8, wherein the processor is further configured to integrate the cross-correlation term to estimate the cross-transmission range of the object.

13. The radar system of claim 8, wherein the processor is further configured to combine the estimated cross-transmission range of the object from the cross-correlation term with an estimate of a self-transmission range of the object from a self-transmission echo.

14. The radar system of claim 8, wherein the processor is further configured to navigate the vehicle with respect to the object based on the estimated cross-transmission range.

15. A vehicle, comprising:
a first radar configured to transmit a test signal;
a second radar separated from the first radar by a selected distance, the second radar configured to receive a total signal that includes the test signal received directly from the first radar and a reflection of the test signal from the target; and
a processor configured to:
perform a non-linear operation on the total signal to obtain a cross-correlation term of the directly received test signal and the reflection signal; and
estimate a cross-transmission range of the object from the cross-correlation term.

16. The vehicle of claim 15, wherein the first radar and the second radar are unsynchronized.

17. The vehicle of claim 15, wherein the processor is further configured to perform the non-linear operation by performing at least one of: (i) squaring the total signal; (ii) obtaining a scalar product of the total signal; and (iii) obtaining an absolute value of the total signal.

18. The vehicle of claim 15, wherein the processor is further configured to apply a filter to a result of the non-linear operation.

19. The vehicle of claim 15, wherein the processor is further configured to integrate the cross-correlation term to estimate the cross-transmission range of the object.

20. The vehicle of claim 15, wherein the processor is further configured to combine the estimated cross-transmission range of the object from the cross-correlation term with an estimate of the self-transmission range of the object from a self-transmission echo.
